(19) United States
(12) Patent Application Publication
(10) Pub. No.: US 2007/0009754 A1
(43) Pub. Date: Jan. 11, 2007

(54) Co-continuous metal-ceramic article and method for manufacture thereof

(75) Inventors: Robert Dzugan, Cincinnati, OH (US); Bruce Paul Bardes, Montgomery, OH (US)

Correspondence Address: Bruce P. Bardes, 7651 Comell Road, Montgomery, OH, 45242, US

(73) Assignee: Rapid Ceramic Technologies Ltd

(21) Appl. No.: 11/171,829

(22) Filed: Jun. 30, 2005

Related U.S. Application Data
(62) Division of application No. 10/357,118, filed on Feb. 3, 2003, now abandoned.

(51) Int. Cl. B32B 3/00; C22C 32/00

(52) U.S. Cl. 428/539.5; 428/312.8

(57) ABSTRACT

A co-continuous metal-ceramic (CCMC) article resulting from a chemical reaction between a ceramic preform and a molten metal is disclosed. The ceramic preform is produced by intermixing a precursor material and a particulate ceramic material, shaping that mixture into a predetermined configuration, and transforming the precursor material into a ceramic matrix. Shaping the preform, whether through a simple molding process, or through a sophisticated rapid prototyping process, is disclosed. CCMC articles having regions of different composition and/or properties are also disclosed.

### RELATED PATENT DOCUMENT

This application is a divisional application of pending application Ser. No. 10/357,118, filed Feb. 3, 2003. Priority is claimed for this application, based on the filing date of said pending application.

### BACKGROUND OF THE INVENTION

1. Field of the Invention

This invention relates generally to co-continuous metal-ceramic (CCMC) composite articles, and to ceramic preforms and methods used in the manufacture thereof. In particular, the invention relates to methods for the manufacture of ceramic preforms, and the preforms made thereby; such preforms are especially well suited for use in manufacturing CCMC composites.

2. Description of Related Art

Co-continuous metal-ceramic composites comprise interlocking metallic and ceramic phases, both of which are substantially continuous throughout the material. CCMC composites are useful in applications that require light weight, moderately high strength, high stiffness, moderate impact strength, good thermal conductivity and resistance to loss of strength at elevated temperatures. As an example, a CCMC material comprising an aluminum-rich metallic phase and an alumina ceramic phase is roughly half as dense as cast iron, yet its strength level is nearly as high. One application where CCMC can offer functional superiority over cast iron is a rotor for an automotive disk brake. CCMC brake rotors have not achieved any significant usage in the automotive industry because of the higher manufacturing cost thereof. Until the manufacturing cost for CCMC components can be reduced, widespread usage in the automotive industry is unlikely. Other examples of applications for CCMC articles may be found in the aerospace industry, where the combination of properties achievable with CCMC materials can be very attractive. Also, the issue of manufacturing cost is less important than in the automotive industry.

There are two major technologies for producing CCMC materials. One technology, exemplified by the teachings of Newkirk et al (U.S. Pat. No. 4,713,360), utilizes a vapor phase process for developing the CCMC structure. The other technology, described by Breslin, and Strange and Breslin (U.S. Pat. Nos. 5,214,011 and 5,728,638, respectively), utilizes a liquid phase process for developing the CCMC structure. The Breslin and Strange technology appears to be better suited for manufacturing processes involving significant product quantities, or processes and products where manufacturing costs are a critical consideration.

In accordance with the teachings of Breslin and Strange, a sacrificial ceramic body is placed in contact with a molten metal. During a suitable period of contact between the ceramic body and the molten metal, the molten metal reacts with the ceramic material, chemically reducing portions of the ceramic material, and leaving metal in place thereof. In the resulting structure, the metallic and ceramic phases are interlocking, and both are substantially continuous throughout the CCMC. The teachings of Breslin and Strange emphasize the technology relating to chemical reactions between the ceramic body with the molten metal. Their teachings regarding the ceramic body presuppose that one can produce such a body in a predetermined shape. It is believed that lack of commercial success of the Breslin and Strange technology can be attributed to insufficient attention to the manufacture of ceramic bodies, or preforms, that have been specifically tailored to that technology. Thus, special attention to the manufacture of such ceramic preforms is appropriate.

The origins of many of the commonly used methods of manufacturing ceramic articles have been lost in antiquity. Naturally, many of these methods have been updated over the years, but the essential elements of many methods of manufacturing ceramic articles haven't changed very much in centuries. Most of the common methods employ a vehicle, typically water, for facilitating manipulation of ceramic particles into whatever configuration is appropriate to a particular application. In their textbook, “Manufacturing Engineering and Technology” (Fourth Edition), Kalpakjian and Schmid identify three groups of ceramic manufacturing methods: casting, plastic forming and pressing. All of the manufacturing methods in the casting and plastic forming groups, and about half of the methods in the pressing group employ a vehicle such as water; these may be termed wet methods. In terms of the tonnage of ceramic articles produced by these methods, the overwhelming majority is produced by wet methods. The processing methods that do not employ a vehicle, or dry methods, are directly analogous to powder metallurgy methods.

Wet methods for manufacturing ceramic articles contain steps that remove the vehicle essential to the manufacturing process. Those steps may include drying at a relatively low temperature to evaporate most of the vehicle, and baking at a higher temperature to evaporate the remaining vehicle. Where water is the vehicle, drying typically occurs below 212° F. (100° C.), so that the water does not boil, which could cause a ceramic article to literally explode. Water present in ceramic articles may be present as a vehicle, or as water of hydration. Removal of such water is a slow process, particularly if the ceramic article has substantial thickness. In a subsequent manufacturing step, a ceramic article is typically fired at a much higher temperature, thereby creating strong bonds between adjacent ceramic particles.

Dry methods for manufacturing ceramic articles contain steps that simply press the ceramic particles together under high pressure. The pressing may be done at room temperature, or at temperatures high enough for diffusion of the atomic or ionic species present in the ceramic to be appreciable. In the latter case, no subsequent firing is necessary. Where pressing is done at room temperature, it is followed by sintering, which consolidates the powder into a dense article.

During drying, firing or hot pressing operations, a ceramic article may shrink as much as 20 percent. Such shrinkage can be a significant problem if the nature of the ceramic article mandates close dimensional tolerances, as is the case in making ceramic preforms for conversion to CMCC articles.

Another class of ceramic articles, namely, glasses, can be useful as preforms for conversion to CMCC articles. Breslin and Strange describe such usage. However, glass preforms are typically prepared by some variation of a melting and casting process, where maintaining specified dimensions can be difficult. Further, conversion of glass preforms to CCMC articles typically involves chemical conversion of virtually the entirety of the glass material, further creating problems in maintaining specified dimensions.

Given the desirability of manufacturing articles as quickly as possible, particularly in the contexts of product development and custom product design, there has been a continuing search for more rapid methods for making articles. Such methods may be collectively identified as rapid prototyping (RP) methods. Kalpakjian and Schmid have identified seven such RP methods. RP technology is particularly attractive in the context of making preforms for conversion to CCMC articles, for making such preforms by conventional ceramic technology is extremely time-consuming.

One example of how rapid prototyping can be employed to accelerate development of new products is the use of stereolithography (SLA) to make patterns for investment casting. SLA was developed by Hull (U.S. Pat. No. 4,575,330). In a common embodiment of the SLA process, a thin film of liquid photosensitive polymer resin is spread on a build table. A localized spot of light, preferably a laser beam, is moved over the film of resin, causing polymerization of the resin wherever the light strikes it. After achieving polymerization in all desired regions of this layer of resin, the build table is lowered into a vat of resin, a new layer of resin is spread over the first layer, and the process is repeated. Movement of the spot of light is controlled by a computer system, which causes beam movements corresponding to the configuration of the desired workpiece, as defined in a computer-aided drafting (CAD) file. While SLA is useful in making a pattern for investment casting, it does not address the matter of making a ceramic preform for conversion to a CCMC article. In an alternate form of the SLA process, the workpiece is lifted from a shallow bath of resin. Polymerization occurs as a result of directing the spot of light through a window at the bottom of the bath.

Crump (U.S. Pat. Nos. 5,121,329 and 5,340,433) has developed an RP process, which he termed fused deposition modeling (FDM). In the FDM process, a thin filament of thermoplastic or wax material is heated and extruded through a small orifice in a movable deposition head. Molten (or nearly molten) material extruded through the deposition head impinges previously deposited material, and solidifies upon contact therewith. Movement of the deposition head is controlled by a computerized control system.

Deckard (U.S. Pat. No. 5,639,070) has developed another RP process, which he termed selective laser sintering (SLS). In the SLS process, a thin layer of powder is spread over a build table. A laser beam is moved over the layer of powder so that the powder particles are sintered together wherever the laser beam has been aimed. After the desired localized sintering is achieved on the first layer of powder, a second layer of powder is spread over the first, and the process is repeated. Ceramic articles may be made by the SLS process. However, the localized heating to cause sintering can also cause sufficient thermal shock to crack the workpiece. In a variation of the SLS process, Langer et al (U.S. Pat. Nos. 5,460,758 and 6,155,331) have taught the use of powder particles coated with a resin layer. Their teachings indicate that the green strength of a fabricated article can be increased without the thermal stresses that often exist in an article made by the SLS process. However, both the Deckard method and the variation described by Langer et al are vulnerable to considerable shrinkage during manufacture.

Sachs et al (U.S. Pat. No. 5,204,055) have developed yet another RP process, which they termed three-dimensional printing (3D printing). In the 3D printing process, a thin layer of powder is spread over a build table. A liquid binder material is selectively deposited over designated regions of the layer of powder. A print head generally similar in function to a computer ink jet printer is useful for depositing the binder. After deposition of binder on the first layer of powder has been completed, a second layer of powder is spread over the first, and the process is repeated. After the entire article has been thusly created, it is sintered to achieve whatever densification is appropriate. Ceramic articles may be made by the 3D printing process. However, considerable shrinkage may occur during sintering, so that an article that is dense enough to have useful strength may be too distorted to serve its intended function.

The teachings of Szweda, Millard and Harrison (U.S. Pat. Nos. 5,306,554, 5,488,017 and 5,601,674) teach a method for developing a ceramic matrix for a composite material comprising ceramic reinforcing fibers in a ceramic matrix. Specifically, Szweda et al teach the use of a silicone resin precursor as a means of achieving a ceramic matrix that is substantially silica and/or silicates. For their application, it was desirable that the entire composite article would be laid up in its intended configuration before the silicone resin precursor was transformed to a ceramic matrix. The context of the present invention, namely, fabricating a ceramic preform for conversion to a CCMC article, preferably by RP technology, working from a CAD file of the finished part, presented process requirements that were significantly contrary to the problems addressed by Szweda et al.

### SUMMARY OF THE INVENTION

Briefly, the present invention provides a CCMC by first providing a ceramic article, or preform, that can be produced in a short time, employing a novel combination of chemical transformations with various forming processes. The preform is subsequently converted to a CCMC. The key feature of the invention is the use of a precursor material that is amenable to processing by a variety of forming processes, including rapid prototyping processes. The precursor material is typically provided as a liquid that can be transformed to a solid, either during or immediately following fabrication of an article by a rapid prototyping process. This attribute of the precursor material may be achieved by employing a monomeric resin that is polymerized during processing. The polymerized resin is subsequently transformed into a ceramic matrix material, preferably by oxidation. Particulate ceramic material that had been intermixed with the liquid precursor material becomes embedded in the ceramic matrix material. Further chemical interaction between the particulate ceramic material and the ceramic matrix material develops a chemical bond therebetween. Still further chemical interaction therebetween can create a new chemical species. The sequence of chemical interactions typically results in transformation of substantially all of the precursor material into ceramic matrix material. Depending upon the nature of the specific materials selected for a particular application, formation of the new chemical species may consume part, or all, of either the particulate ceramic material or the ceramic matrix material. A ceramic article made in accordance with the present invention is subsequently converted to a CCMC article.

The shaping process of the present invention can be as simple as molding a quantity of precursor material intermixed with particulate ceramic in a shaped mold. The precursor material is typically polymerized in the mold prior to removal therefrom.

The process of the present invention admits to the use of several rapid prototyping processes, and variations thereof. For example, a mixture of silicone resin and particulate ceramic material may be substituted for the polyester resin typically employed in stereolithography. In another embodiment of the process of the present invention, a silicone resin is substituted for the binder generally employed with 3D printing rapid prototyping process. Shining ultraviolet light on the resin after deposition of each new layer of material causes polymerization to occur. In a third embodiment of the process of the present invention, a slurry of finely ground particulate ceramic material in a vehicle of monomeric silicone resin is printed in successive layers onto a convenient substrate. After each layer is printed, it is exposed to ultraviolet light, thereby polymerizing the silicone resin. Each of these variations of the process of the present invention offers certain advantages. However, the same fundamental chemical interactions and transformations occur during each variation of the process. Thus, the process of the present invention must be viewed broadly, to encompass these, and other, rapid prototyping processes. Ceramic preforms made by these, and other, RP technologies can typically be produced in a matter of hours, rather than the several days that might be required to produce such preforms by conventional ceramic technology.

In several embodiments of the present invention, a ceramic preform is subsequently converted to a CCMC article. Such conversions are typically achieved by placing the preform in a bath of molten metal.

Specific features of the CCMC article and process of the present invention are detailed in the following Detailed Description of the Invention and the accompanying drawings. Several preferred modes of tie present invention are also described therein. Those having ordinary skill in the ceramic and metal casting arts will recognize alternative means of accomplishing the objects of the present invention, all of which are deemed to be equivalent to and to fall within the scope of the present invention.

### DESCRIPTION OF THE DRAWINGS

FIG. 1 is a schematic representation of part of the process of the present invention, showing particulate ceramic material and precursor material, transformation of the precursor material to a ceramic matrix material, and chemical interaction of the between the particulate ceramic material and the ceramic matrix material to form a new chemical species.

FIG. 2 is a schematic representation of part of the process of the present invention, showing conversion of a ceramic preform to a CCMC article.

### DETAILED DESCRIPTION OF THE INVENTION

Understanding the teachings of Breslin and Strange and the prior art RP processes is deemed useful in understanding the present invention.

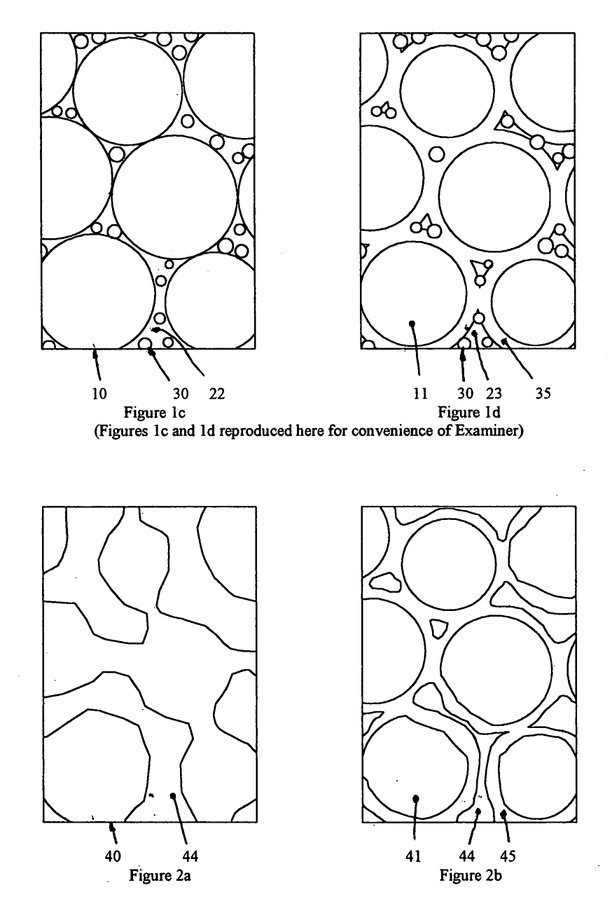

The CCMC article of the present invention is advantageously described with reference to the Figures described hereinabove. The manufacturing process for that article is likewise advantageously described with reference to the Figures. Use of that ceramic article as a preform for conversion to a CCMC article is also advantageously described with reference to FIG. 2.

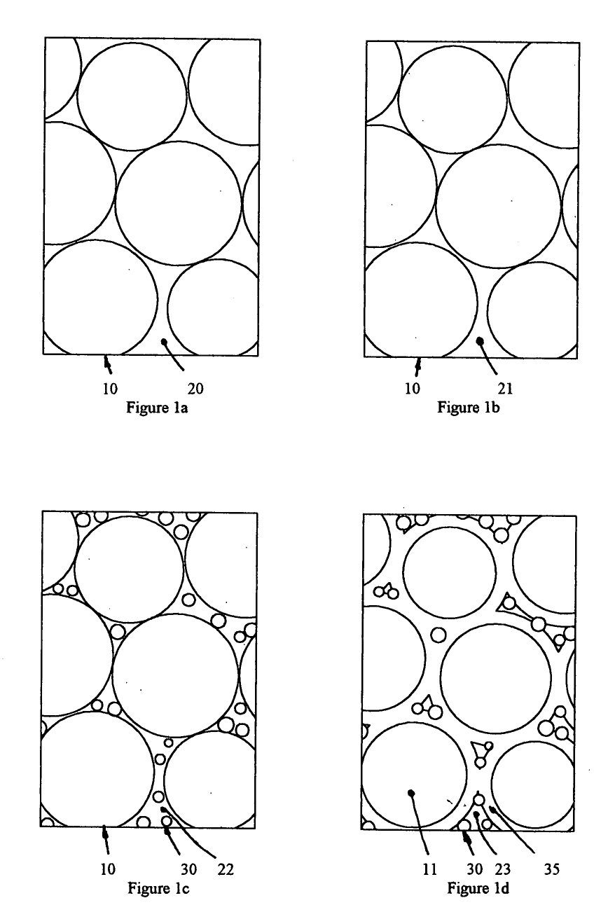

The chemical transformations that typically occur during practice of the early portion of the present invention are depicted in FIG. 1, which comprises four schematic micrographs of the same region in a material as it might exist at various stages of the process. FIG. 1a illustrates the intermixed combination of particulate ceramic material 10 and monomeric precursor material 20. Note that the precursor material is in intimate contact with the particulate ceramic material. FIG. 1b illustrates the effect of polymerizing the precursor material 20 shown in FIG. 1a to a polymer matrix material 21. FIG. 1c illustrates the chemical transformation of the polymer matrix material 21 shown in FIG. 1b to a ceramic matrix material 22. Using the process and materials described herein, and perhaps other materials as well, a chemical bond between the ceramic matrix material 22 and the particulate ceramic material 10 is achieved thereby. The transformation typically produces gaseous byproducts such as water vapor and carbon dioxide; pores 30 are typically formed during the transformation. FIG. 1d illustrates the formation of a new chemical species 35 from reaction of the particulate ceramic material 10 with the ceramic matrix material 22. In FIG. 1d, pockets of unreacted particulate ceramic material are shown at 11 and pockets of unreacted ceramic matrix material are shown at 23. For simplicity, it assumed that the size, shape and distribution of pores 30 are unaffected by the formation of the new chemical species 35. This assumption is an oversimplification, for the chemical diffusion necessary to achieve the formation of a new chemical species is quite sufficient to achieve movement, shape change and even consolidation of the pores. This sequence of chemical reactions can occur in most embodiments of the present invention, whether shaping of a ceramic article is achieved by a simple molding process, or by a sophisticated RP process.

Many different particulate ceramic materials can be employed in the present invention. Representative materials are included in the group consisting of silica, alumina, titania, zirconia, yttria, magnesia, analogous nitrides, carbides and sulfides, mixtures thereof; and intermediate compounds therebetween. In the context of the present invention, the term analogous nitride refers to a compound in which nitrogen has replaced the oxygen in the named compound. An intermediate compound is a substance resulting from a reaction between two or more members of the group; for example, mullite is an intermediate compound resulting from a reaction between silica and alumina. The term mixture is taken to mean a physical mixture of two or more particulate species from the group. One skilled in the ceramic arts might identify other particulate ceramic materials that behave in a similar fashion to the ceramic materials described hereinabove, such other particulate ceramic materials are deemed to be equivalent to those specifically identified herein.

Modifying the process of the present invention can result in changes in the size and distribution of the pores, and the extent to which the particulate ceramic material reacts with the ceramic matrix material. Such factors may facilitate the subsequent reaction of a ceramic preform with molten metal, to form a CCMC article.

In one embodiment of the present invention, the monomeric precursor material 20 is a low-viscosity silicone resin. The resin also contains a photosensitive substance that initiates polymerization of the resin when it is exposed to light, preferably ultraviolet light. Even though the resin is initially intermixed with particulate ceramic material at the outset of the present manufacturing process, the low viscosity of the resin makes the resulting mixture amenable to processing by SLA technology, in a manner similar to that described by Hull. Because monomeric silicone resins are typically produced as two separate components, which are mixed together shortly before use, the premixed resin is perishable, having a rather short working life. Accordingly, the inverted embodiment of the SLA process is deemed preferable for the present invention, because a much smaller volume of the perishable precursor material is required in this configuration. In other embodiments of the present invention, the mixture of resin and particulate ceramic material may be deposited in variations of the 3D printing and FDM processes, as described below. In order to fabricate a preform by a molding operation, the use of a heat-sensitive substance for initiating polymerization of the silicone resin may be preferred.

Polymerizing the silicone resin 20 results in a solid substance 21 that has a modest amount of structural strength, at least enough to hold the preform being made together for further processing. In the next step of processing, the solid silicone substance 21 is oxidized to form silica and/or silicates, shown at 22. Heating the solid silicone substance 21 in air at temperatures in the range of 1100-1400° F. (550-750° C.) is generally sufficient for this purpose. The preferred temperature depends upon many factors, including the specific silicone resin employed in the process, size of the workpiece, and desired distribution of porosity 30 in the workpiece. Further heating, at a higher temperature, may cause the silica 22 to react with the particulate ceramic material 10 to form a new chemical species 35. If the particulate ceramic material is alumina, the new chemical species will be mullite. The appropriate temperature for this reaction depends on what material(s) comprises the particulate ceramic material 10. In accordance with the teaching of Szweda et al, temperatures as high as 2550° F. (1400° C.) may be appropriate. It should be noted that if the intended application of the ceramic preform admits to a structure comprising ceramic particles in a matrix of silica, this last step may be omitted from the process. Such a structure is potentially useful in a ceramic preform that will be subsequently converted to a CCMC article. However, silica softens at relatively low temperatures, much lower than mullite, for example, so that interaction between alumina particles with a silica matrix to produce mullite can be useful in extending the high temperature capability of the completed CCMC article.

In the context of the present invention, it is contemplated that substances other than silicone resin may be incorporated in the precursor material. For example, Szweda et al have taught the utility of mixing a moderate percentage of an epoxy resin into the silicone resin. Other precursor materials that transform to ceramic substances such as alumina may be intermixed with the silicone resin.

As indicated above, and illustrated in FIG. 1, the monomeric precursor material 20 is intermixed with particulate ceramic material. That ceramic material can be a single chemical species, or a mixture of two or more chemical species. Under most circumstances, the particulate ceramic material will be comprised primarily of the species that will become an essential component of the completed ceramic preform. In one embodiment of the present invention, that essential component is alumina. However, a wide variety of other particulate materials can be employed. For example, the use of silica particles can result in a ceramic preform that contains a high percentage of silica.

In the context of RP processes, the preferred size of the particulate ceramic material depends on several factors. It is essential that the individual ceramic particles must be smaller than the thickness of the layer of precursor material applied to the build table. That thickness is typically about 5 mils or less. [One mil is 0.001 inch, or 25 micrometers or microns.] Unduly small ceramic particles create problems in handling. For the purposes of the present invention, it is believed that the preferred particle size lies between about 0.03 mil (0.75 micron) in diameter and about 3 mils (75 microns) in diameter. It is believed that a more preferred particle size lies between about 0.04 mil (1 micron) and about 2 mils (50 microns).

Other species of particulate ceramic material may be employed in the method of the present invention. For some purposes, it may be useful to provide multiple chemical species in the particulate ceramic material 10 that subsequently reacts with silica, specifically to produce a final structure that is a three-component ceramic compound, or a structure comprising two or more distinct phases. Also, Szweda et al have taught that minerals having a lathy-type structure, notably pyrophyllite, are very useful in controlling shrinkage that may occur during high temperature processing.

Another embodiment of the present invention incorporates an RP process similar to 3D printing. In this embodiment, particulate ceramic material is spread on a build table, and droplets of silicone resin are “printed” wherever needed to create solid material in the finished part. The intermixing of precursor material and particulate ceramic material occurs at this point. The silicone resin is then polymerized by flooding the entire printed layer with light, preferably ultraviolet light. The method of the present invention differs from that of Sachs et al, in that Sachs et al teach the use of a binder that is evaporated or burned up in subsequent processing, leaving little or no useful material to be incorporated into the ceramic preform, whereas the present process employs a precursor that becomes an integral component of the ceramic preform.

In another embodiment of the present invention, the particulate ceramic materials are provided as very small particles, between about 0.0004 mil (0.01 micron) and 0.4 mil (10 microns) in diameter. These particles are intermixed with the precursor material, and the mixture is deposited onto a build table (or a previously printed layer) by a printer that is generally similar to an ink jet computer printer. After each layer is deposited, it is bathed in light, preferably ultraviolet light, to polymerize the precursor material. Although this embodiment permits the use of rapid printing technology, for computer printers routinely provide printing rates of 10 pages per minute, the effective build rate of this embodiment is limited by the thickness of each deposited layer. This embodiment bears some similarity to both FDM and 3D printing processes, but it is distinct from either.

In the context of the present invention, the precursor material is intermixed with the particulate ceramic material, to bring the two substances into intimate contact. In theory, the term “intimate contact” would imply that each individual ceramic particle would be completely coated with precursor material. However, achieving such a condition in a production manufacturing process is, practically speaking, impossible. Thus, the tern “intimate contact” must be interpreted broadly, to indicate that reasonable efforts to intermix the precursor material and particulate ceramic material are taken. It is assumed that intimate contact is achieved in the SLA, FDM and 3D printing process, as described above. The term is also taken to include the possibility that wetting agents to facilitate such intimate contact can be included in the precursor material.

In the context of the present invention, various processes for manufacturing ceramic articles are directed toward producing preforms for subsequent conversion to CCMC articles, such processes represent preferred embodiments of the present invention. With the RP processes of the present invention, a ceramic preform may be produced directly from a CAD file describing the configuration of the finished CCMC article. Current computer technology permits enlarging the size of the finished preform to compensate for shrinkage during various steps in the manufacturing process. The process of the present invention is employed to create a ceramic preform having a configuration defined by the CAD file containing the aforementioned modifications.

If the nature of the finished CCMC article requires the holes or internal passages, the process of the current invention admits to the manufacture of features corresponding to such holes or internal features simultaneously with manufacture of the preform itself.

As indicated above, Breslin has taught a method for producing such articles by treating ceramic preforms with molten metals, notably aluminum and aluminum alloys. In accordance with his method, a preform can be treated in molten aluminum or aluminum alloy at a temperature between about 1925 and 2300° F. (about 1000 and 1250° C., respectively). Breslin reports a growth rate of about 3 inches (8 centimeters) per day, so the time required for converting a ceramic preform to a CCMC article is typically measured in days.

Employing the process of the present invention greatly facilitates the Breslin method of manufacture, because preforms made according to the present invention are dimensionally accurate, uniform in internal structure and speedily produced without the need for time-consuming drying operations. Further, the process of the present invention admits the possibility of creating a composite preform, comprising a continuous silica matrix with discontinuous particles of another ceramic material incorporated therein. It is believed that such a composite structure will respond differently to Breslin's method than will a ceramic preform having uniform structure, perhaps reducing the volumetric shrinkage reported by Breslin. In addition, any porosity present in preforms made in accordance with the present invention will be confined to the silica matrix. The presence of such pores tends to accelerate the conversion reaction, in which silicon present in the silica matrix is at least partially replaced by reactive metal, such as aluminum, present in the molten metal. Thus, a structure containing an alumina ceramic component and an aluminum (or aluminum alloy) metallic component is developed.

Strange and Breslin have also taught that “inert” metals, such as copper, nickel and silver, may be incorporated in the molten metal bath. They also teach that the “inert” metal forms the continuous metal structure in the CCMC material, while the aluminum displaces silicon in the ceramic preform. The use of “inert” metals in manufacturing CCMC materials raises the temperature capability and corrosion resistance of the CCMC material. However, the density of such materials is greater than a CCMC material made in a molten metal bath containing primarily aluminum.

The result of reacting the ceramic preform with molten metal is shown in FIG. 2. FIG. 2a illustrates the structure resulting from reacting a ceramic preform containing particulate ceramic material 10 and a ceramic matrix 22, such as that shown in FIG. 1c, with molten metal. In this embodiment of the invention, it is presumed that little or no reaction between the particulate ceramic material and the ceramic matrix has occurred. Placing the ceramic preform shown in FIG. 1c in a bath of molten metal, typically comprising molten aluminum or an alloy thereof, causes the molten metal to react with the ceramic matrix 22, especially if the ceramic matrix contains significant amounts of silica. As shown in FIG. 2a, the molten metal replaces most, or all, of the ceramic matrix in the resulting structure, and fills the pores 30, such that after cooling, the structure comprises remnants of the particulate ceramic material 40 and a metallic phase 44 interlocked therewith. The presence of a liquid metal can facilitate the diffusion of atoms and/or ions of the particulate ceramic material to bond individual particles to each other, making the resulting structure 40 substantially continuous throughout the structure of the CCMC. In addition, the reaction between the particulate ceramic material and the molten metal typically creates a new ceramic species, often comprising a cation from the molten metal and an anion from the ceramic matrix material. This new ceramic species is not shown in FIG. 2a, it is presumed to be joined with the ceramic phase 40.

In another embodiment of the invention, a significant reaction between the particulate ceramic material and the ceramic matrix material occurs during manufacture of the ceramic preform. As shown in FIG. 1d, the structure of this material typically contains unreacted particulate ceramic material 11, unreacted ceramic matrix material 23, pores 30 and a newly-formed chemical species 35. The nature of chemical reactions between a molten metal and the material of the preform, shown in FIG. 1d, depends on the specific chemical species present in the preform. The structure resulting from one such set of chemical reactions is illustrated in FIG. 2b. In this example, the structure comprises remnants of the particulate ceramic material 41, a metallic phase 44 interlocked therewith, and a third phase 45, possibly a remnant of the newly-formed phase shown in FIG. 1d at 35, or possibly a product of that newly-formed phase with the molten metal. Depending on the specific chemical species utilized in a particular CCMC, the third phase 45 may be a second ceramic phase in the structure, and it may or may not be continuous throughout the structure of the CCMC.

The present invention also contemplates the possibility of depositing at least two different substances during the RP processing. The substances might differ in the combination of chemical species included in the particulate ceramic material, or they might differ in the nature and/or chemical composition of the precursor material. Further, the process of the present invention can be manipulated to develop a preform that contains a substance produced by a reaction between a particulate ceramic species and the silica matrix. In such embodiments of the present invention, a variation in chemical composition, and mechanical and/or physical properties between different regions of the resulting ceramic preform can be achieved.

These structures may be achieved in many ways. For example, two different substances can be delivered through a deposition apparatus analogous to the print head of a computer printer capable of color printing, thus creating regions having different compositions in the preform. In such a ceramic article or preform, comprised of regions having different chemical compositions, different response of the various regions to treatment in molten metal might be expected. Thus, one can fabricate CCMC articles having variations in composition, structure and properties, according to the distribution of the two substances deposited during RP processing. Such CCMC articles might be useful in applications where anisotropy in thermal conductivity, or in some other mechanical or physical property, might be required.

This example illustrates the capability of the present invention to produce a ceramic preform, and a subsequently produced CCMC article, wherein the structure and properties have been specifically tailored to the needs of the particular application.

In making a ceramic preform for the process of the present invention, it may be useful to deposit two substances that are completely different in chemical nature, i.e., one substance can be a mixture of particulate ceramic material and precursor material, as described herein, and the other can be a polymeric material that would be burned away during subsequent processing. The latter would be useful in building a ceramic preform that comprises overhanging features that would be unsupported during deposition, but for the presence of a disposable support deposited during the manufacturing process. The resulting ceramic preform would then be reacted with molten metal, as described hereinabove.

The essential characteristics of a CCMC article produced in accordance with the present invention include: (1) interlocking metallic and ceramic phases; (2) both phases are substantially continuous throughout the article; (3) electrical conductivity in the CCMC is of the same magnitude as the electrical conductivity of a monolithic metallic body having the same composition, size and configuration as the CCMC; and (4) if the metallic phase is leached out of the CCMC, the remaining ceramic material is self-supporting.

While preferred embodiments of the present invention have been described herein in order to better illustrate the principles and applications thereof, it is understood that various modifications or alterations may be made to the present invention without departing from the true scope of the invention set forth in the appended claims.

We claim:

1. A CCMC article comprising interlocking metallic and ceramic phases, each of which is substantially continuous therethrough;
wherein the CCMC is manufactured by reacting a liquid metal with a ceramic preform; and wherein the ceramic preform results from a chemical interaction between a particulate ceramic mineral and a ceramic matrix material; wherein:
the particulate ceramic material and a precursor material are intermixed, so that particles of the particulate ceramic material are in intimate contact with the precursor material;
at least a portion of the precursor material is chemically transformed to form the ceramic matrix material; and
the chemical interaction between the particulate ceramic material and the ceramic matrix material produces a chemical bond therebetween.

2. The CCMC article as recited in claim 1, wherein the liquid metal is selected from the group consisting of: aluminum, iron, nickel, cobalt, magnesium, and alloys of any of the aforementioned metals.

3. The CCMC article as recited in claim 1, wherein the precursor material is provided in liquid form.

4. The CCMC article as recited in claim 3, wherein the precursor material comprises a silicone resin.

5. The CCMC article as recited in claim 4, wherein the precursor material is chemically transformed by oxidation, and wherein the ceramic matrix comprises at least one member of a group consisting of silica and silicates.

6. The CCMC article as recited in claim 1, wherein the precursor material is provided in gaseous form.

7. The CCMC article as recited in claim 1, wherein the particulate ceramic material comprises at least one member of the group consisting of silica, titania, alumina, zirconia, yttria, magnesia; analogous nitrides, carbides and sulfides; mixtures thereof; and intermediate compounds therebetween.

8. The CCMC article as recited in claim 1, wherein the precursor material comprises a plurality of chemical species.

9. The CCMC article as recited in claim 1, wherein the ceramic preform has a configuration developed through use of rapid prototyping process.

10. The CCMC article as recited in claim 9, wherein the rapid prototyping process comprises stereolithography.

11. The CCMC article as recited in claim 9, wherein the rapid prototyping process comprises three-dimensional printing.

12. The CCMC article as recited in claim 9, wherein the rapid prototyping process comprises fused deposition modeling.

13. The CCMC article as recited in claim 9, wherein the rapid prototyping process comprises selective laser sintering.

14-30. (canceled)

31. A CCMC composite article made by a process comprising the steps of:
(a) selecting a plurality of particulate ceramic materials, each comprising at least one chemical species;
(b) intermixing a precursor material with at least a portion of each particulate ceramic material to achieve intimate contact between the precursor material and the portion of each particulate ceramic material, thereby creating a plurality of intermixed materials;
(c) shaping the intermixed materials into a predetermined configuration, thereby creating a preform characterized by regions of differing compositions, each such region having a characteristic composition attributable to the specific combination of particulate ceramic material and precursor material employed therein;
(d) chemically transforming at least a portion of the precursor material in the preform to a ceramic matrix material;
(e) chemically interacting at least a portion of the particulate ceramic material with at least a portion of the ceramic matrix material to create a ceramic preform; and
(f) chemically reacting the ceramic preform with a molten metal, thereby creating the CCMC article.
